(19) United States
(12) Patent Application Publication
(10) Pub. No.: US 2025/0174748 A1
(43) Pub. Date: May 29, 2025

(54) ENHANCED DISCHARGE PROCESSES

(71) Applicant: NORTHVOLT REVOLT AB, Stockholm (SE)

(72) Inventors: Berfu KARLI, Vällingby (SE); Ragnar SJÖDAHL, Stockholm (SE); Mahmood ALEMRAJABI, Solna (SE)

(21) Appl. No.: 18/843,051

(22) PCT Filed: Mar. 3, 2023
(86) PCT No.: PCT/EP2023/055406

§ 371 Date: Aug. 30, 2024

(30) Foreign Application Priority Data
Mar. 3, 2022 (SE) 2250287-6

(51) Int. Cl. H01M 10/54

(52) U.S. Cl. CPC H01M 10/54

(57) ABSTRACT

The current disclosure relate to processes and systems for discharging of rechargeable battery cells, said battery cells having electric poles and one or more vents, the method comprising puncturing a vent of a battery cell, submerging the battery cell in a discharge medium such that at least the electric poles and the punctured vent of the battery cell are covered with the discharge medium, wherein the discharge medium is an electrically conductive fluid, discharging the one or more battery cell until it has reached a target cell voltage threshold by allowing the battery cell to be submerged in the discharge medium for a predetermined processing time t, wherein the target cell voltage threshold is above 0V, then removing the one or more battery cell from the discharge medium.

### TECHNICAL FIELD

The present disclosure relates to processes for discharging of batteries, battery cells and modules.

### BACKGROUND

Rechargeable or secondary batteries, including battery cells, battery modules and battery packs, find widespread use as electrical power supplies and energy storage systems. In particular in the transportation sector, to achieve the goal of the Intergovernmental Panel on Climate Change (IPCC) to limit global warming to 1.5° C., electric vehicles (EVs) powered by renewable energy have been tapped as the primary means to achieve decarbonization. As a result of the push from policymakers and global awareness, the number of electric vehicles bought and used worldwide will significantly increase in the next years and, as a consequence thereof, also the number of batteries at their end of life will significantly rise considering a typical life span of 10 years.

Batteries include toxic heavy metals and may release harmful gases with global warming potential if improperly disposed. Thus, recycling of batteries is imperative to meeting the IPCC goal. Furthermore, several of the elements used in EV batteries, such as lithium, cobalt, nickel, aluminum, copper and manganese, are valuable, in particularly considering the increasing demand for electric vehicles one the one side, and the scarcity of resources and the difficult mining conditions on the other side. Thus, saving resources, minimizing pollution and lowering cost are also driving factors for the recycling of batteries.

Current battery recycling processes follow a sequence of discharging and/or disassembly, hydro-or pyrometallurgy, metal extraction and product preparation. Hydrometallurgy, which is considered more environmentally friendly than pyrometallurgy, is preceded by crushing the batteries. For safety reasons, discharging of the batteries is crucial, because during the crushing process the anode and cathode materials could meet, thereby causing a short circuit or self-ignition. If the voltage potential between the anode and cathode is high enough, it could cause thermal runaway, that is, rapid, uncontrolled release of the stored electrical energy, causing the cell to open explosively or to cause a fire.

Discharging methods may employ a discharge solution into which the batteries are submerged. Processes are known for discharging of rechargeable batteries, in which the batteries to be discharged are inserted into a discharge mixture of a salt solution. The salt solution is preferably a sodium chloride or sodium carbonate salt solution. In previous solutions, the discharge mixture is cooled with a cooling device to reduce the risk of thermal runaway.

In order to lower the cost and risk of battery recycling, a discharging process should be safe, that is, reduce the risk to the recycling facility by minimizing the fire or explosion hazard, minimizing or eliminating human interaction with the battery pack and should have a short enough duration to not become a bottleneck when a large quantity of batteries enter the facility, and should be sustainable, lowering global warming potential and other environmental hazards. Also methods for recycling broken or damaged batteries or cells to be able to recycle all batteries are needed. There is a great demand in industry for a discharging process that fulfills one or more of the above-outlined objects.

### SUMMARY

An object of the present disclosure is to provide new processes which seek to mitigate, alleviate, or eliminate the above-identified deficiencies in the art and disadvantages singly or in any combination. This object is obtained by a process for discharging of rechargeable batteries, battery modules or battery cells, said battery cells, said battery cells having electric poles and one or more vents, wherein the method comprises puncturing a vent of one or more battery cell, submerging the one or more battery cell in a discharge medium such that at least the electric poles and the punctured vent of the one or more battery cell are covered with the discharge medium, wherein the discharge medium is an electrically conductive fluid, discharging the one or more battery cell until it has reached a target cell voltage threshold by allowing the battery cell to be submerged in the discharge medium for a predetermined processing time t, wherein the target cell voltage threshold is above 0 V, and removing the one or more battery cell from the discharge medium.

In some aspects, the process will also include the following steps to be performed before the discharging process; reading an ID tag of each one of the one or more battery cell, thereby obtaining information indicating one or more properties of the one or more battery cell; and sorting the one or more battery cell into a group of a plurality of groups of battery cells based on the obtained information for the battery cell, wherein each group of the plurality of groups will be treated in a separate discharging process in the following steps.

According to some aspects, discharging the one or more battery cell until it has reached a target cell voltage threshold and removing the one or more battery cell from the discharge medium comprises allowing the one or more battery cell to be submerged in the discharge medium for a predetermined processing time t, removing the one or more battery cell from the discharge medium, performing a voltage validation of remaining cell voltage of the one or more battery cell by measuring the remaining cell voltage of the one or more battery cell, and on condition that the voltage validation shows that the remaining cell voltage is at or below the cell voltage threshold, sending the one or more battery cell to a next step in a battery cell recycling process, and on condition that the voltage validation shows that the remaining cell voltage is above the cell voltage threshold, submerging the one or more battery cell in the discharge medium for additional discharging during an additional processing time, and removing the one or more battery cell from the discharge medium once said additional processing time has passed. Sending the one or more battery cell to a next step in a battery cell recycling process may comprise sending the one or more battery cell to be washed and then crushed, before metal extraction.

In some aspects, the process further comprises recovery of the electrically conductive fluid of the discharge medium by removing impurities from the electrically conductive fluid to obtain a raw electrically conductive fluid, and adjusting the concentration of the obtained raw electrically conductive fluid for reuse.

The target cell voltage threshold is typically in the range of 1.0 V to 2.5 V, such as 1.8 V, and the processing time in the range of 2-8 hours. The processing time may be determined based on the properties of the battery cell, either as an estimated discharge time to reach a target cell voltage for said battery cell, or based on the estimated discharge time range of the group that the battery cells has been sorted to.

Other objects and advantages will become apparent to those skilled in the art from a review of the ensuing detailed description, which proceeds with reference to the following illustrative drawings, and the attendant claims. The steps of any process disclosed herein do not have to be performed in the exact order disclosed, unless explicitly stated.

### BRIEF DESCRIPTION OF THE DRAWINGS

The above and other aspects of the present invention will now be described in more detail, with reference to the appended figures. The figures are not necessarily to scale, and generally only show parts that are necessary in order to elucidate the inventive concept, wherein other parts may be omitted or merely suggested.

FIG. 1 illustrates a battery cell having a positive and negative pole and a vent, where FIG. 1A depicts a cylindrical cell and FIG. 1B a prismatic cell.

FIG. 2 illustrates discharging process of the present disclosure where FIG. 2A includes an adaptive flow of cells based on state of charge (SOC), and FIG. 2B illustrates a flow chart of an example process from charged cells to uncharged cells.

FIG. 3 is a flow chart illustrating a process according to the present disclosure.

FIG. 4 illustrates a solution discharge process of the present disclosure.

FIG. 5 shows a diagram of a comparison of solution discharge rate with a punctured vent and without a punctured vent.

FIG. 6 shows a diagram of a comparison of solution discharge rate with a punctured vent and without a punctured vent.

FIG. 6 shows an enlarged version of the vented case illustrated in FIG. 5.

FIG. 7 shows a diagram illustrating the failure rate in % for 45 different cells discharged according to the present processes.

### DETAILED DESCRIPTION

The present disclosure relates to new and enhanced methods for discharging of rechargeable batteries, which allows fast and effective discharging of batteries and battery cells, or parts thereof, and which methods may also be used if the batteries or cells are broken or damaged, and hence not suitable for or rejected by regular discharging processes.

Aspects of the present disclosure will be described more fully hereinafter with reference to the accompanying drawings. The methods disclosed herein can, however, be realized in many different forms and should not be construed as being limited to the aspects set forth herein. Like numbers in the drawings refer to like elements throughout. The features of various embodiments can be combined to form further exemplary aspects of the present disclosure that may not be explicitly described or illustrated. Further it is to be understood that the words and terms employed herein are used for describing specific embodiments only, and is not intended to be limiting, since the scope of the present invention is defined by the appended claims and equivalents thereof.

The terminology used herein is for the purpose of describing particular aspects of the disclosure only, and is not intended to limit the disclosure. As used herein, the singular forms “a”, “an” and “the” are intended to include the plural forms as well, unless the context clearly indicates otherwise.

In some aspects the non-limiting term “battery” or “batteries” is used, which is intended to include a battery cell or battery cells, a battery module or battery modules, which typically contain a plurality of battery cells, and a battery pack or battery packs, which typically contain a plurality of battery modules.

The term “cell voltage” refers to the voltage of the battery/cell, which is determined by the chemical reactions in the battery, the concentrations of the battery components, and the polarization of the battery. The voltage calculated from equilibrium conditions is typically known as the nominal battery voltage. The cell voltage may also be referred to as the “operating voltage”. The cell voltage or remaining cell voltage may be measured using any suitable method in the art. In one example, the cells are removed from the discharge medium, and the remaining cell voltage is determined/measured using a multimeter. This may be done regularly, such as each hour, and/or when the estimated time for arriving at a desired cell voltage threshold has passed. When measuring regularly, the cells may be temporarily removed from the medium, such as for a few seconds, measured, and then put back again.

The term “cell voltage threshold”, “target cell voltage” or “target cell voltage threshold” refers to a threshold set for a discharging process, wherein the discharging process in a discharge medium may be terminated once the battery or cell has reached the threshold, i.e., has a remaining cell voltage being the same as the target cell voltage threshold, or below, by removing the cell from the discharge medium. The cell voltage thresholds of the present disclosure are above 0V.

The “processing time t” refers to a duration of the discharging process while submerged in a discharge medium, starting once a battery cell is submerged into the discharging medium, and ending when the battery cell is removed from the discharge medium, when it should have reached the target cell voltage threshold according to the predetermined processing time, based on an estimation of the discharge time for the battery cell. Based on the properties of the battery cell, which may be obtained by reading an identity (ID) tag of the cell, the discharging time for reaching a certain cell voltage threshold may be estimated. Based on the estimated discharging time to reach a certain target cell voltage for a cell under the present circumstances, a processing time t may be determined, either as the estimated discharge time, or based on an estimated discharge time range for a group of cells with similar estimated discharge times. In some embodiments, the discharging time for reaching a specified cell voltage threshold is estimated based on the properties of the battery cell, such as energy content and a degree that the vent may be opened, and properties of the discharge medium, such as temperature and salt concentration of the discharge medium.

The properties of the battery cell as indicated by the ID tag may be for example a state of charge (SOC) of the cell, and a type/size of the battery cell. Based on these properties, the energy content of the battery cell may be derived, e.g., the energy content is derived based SOC+size/type (size and type of battery typically correlating). Based on said energy content, a discharging time to reach a target cell voltage may be estimated for the battery cell based on previous knowledge of discharging times for reaching certain cell voltage levels for battery cells having similar properties/energy content, where the discharge time is estimated as the time needed for a similar battery of a similar energy content to reach a certain cell voltage. By discharging the battery cell for a processing time t corresponding to the estimated discharge time, the energy content of the battery cell should be reduced until the remaining cell voltage is at or below the desired cell voltage threshold.

Thus, based on the properties of the battery cells, the batteries may be sorted into different groups having similar estimated discharge times, wherein each group has a “discharge time range” for the battery cell group, i.e., a discharge time interval of estimated times being close to each other in duration. Thus, for each group, a predetermined processing time t may be set, which is typically within the discharge time range, such as the medium discharge time within the range, or the longest discharge time within the range. Thus, after being sorted into a specific group, the following discharge process will be carried out separately for each group according to the predetermined processing time t for said group. In some examples, the processing time range may span about 2 hours or less. In one example, three different groups may be used, with predetermined processing times t of 2, 4 and 6 hours, respectively. The processing time ranges for sorting cells falling into said ranges to the respective groups may then be for example 1-3, 3-5 and 5-7 hours, respectively.

The “discharge medium” or “discharge solution” as used interchangeably herein may be an aqueous solution, such as water, or a salt solution, where the term “salt” as used herein refers to a chemical compound consisting of an ionic assembly of cations and anions. Thus, the discharge medium is an aqueous solution comprising a salt concentration of 0-15 wt. %, wherein 0% refers to a water solution comprising no added salt.

The regular standard technique for discharging a battery is electrically using static or dynamic resistance. This resistance is typically in the form of an electronic load which can be applied to a source to discharge it. The device consists of a resistor or a group of resistors, and an electronic control system. With this device, a constant current (CC), constant resistance (CR), constant voltage (CV) or constant power (CP) can be set to discharge the battery. Thus, in said processes for discharging batteries/cells, or parts thereof, batteries/cells which are broken or damaged will be rejected. Further, many processes aim to discharge the batteries completely, referred to as “deep discharge” or full discharging, or nearly completely, to avoid thermal runaway when crushing the batteries. Thus, a bottleneck in the recycling process is the time and effort needed to discharge the cells prior to crushing, where the discharge process is continued typically until the cells are at, or close to, 0 V. Thus, the present prior art methods may not be able to discharge broken batteries, and are, due to the complete discharging, not very fast or efficient.

It has now surprisingly been found that a complete discharge of the batteries are not needed, but that discharging down to a level of approximately 1.0-2.5 V may be enough. This is partly due to that it has been found that a small remaining cell voltage is acceptable in the subsequent processes, and due to, when employing the processes of the invention including puncturing a vent of the battery cell before/while submerging it in a discharge solution, the discharging of the batteries will continue for some time after removing the batteries from the discharge solution. By puncturing the vent, the discharge solution may enter the battery cell, and once the discharge solution enters the battery, it will react with reactive Lithium (Li) on the anode side and form Lithium carbonate (Li2CO3) or Lithium hydroxide (LiOH), which helps the deactivation even if the batteries are not submerged. The discharge will thus occur using three different mechanisms; by water split at the poles which will be improved by presence of electrolyte in the water, by the discharge solution entering the battery and reacting with reactive Li, and by electrolyte leaving the battery and the anode and cathode layer collapsing and short-circuiting, which causes discharge and energy release in terms of heat. Thus, the discharging time for the battery cells may be reduced, both since the process may be aborted above 0 V as full discharging is not needed, but also because it may be aborted above a desirable cell voltage for the following processes as the discharge process will proceed for a while after removal from the discharge medium. Further, by using the solution discharge process of the present disclosure, which may be employed for parts of a battery, also damaged batteries may be discharged, which is not possible using for example electrical discharging methods. The methods may also reduce the risk of voltage rebound/relaxation, where a deeply discharged cell (0 V) returns to 2.5 V after a rest period.

The current disclosure provides solutions to the above-mentioned problems and drawbacks by providing methods which are both fast and possible to use for damaged batteries or cells, and for batteries/cells of all state of charges (SOC). The methods include puncturing of a vent of the batteries/cells, submerging them into a discharge medium/solution, allowing them to be discharged until a certain level, i.e., to or below a certain threshold, before extracting them from the discharge medium. By not allowing the cells to be completely discharged, a more efficient and less time consuming process is obtained. By puncturing the vent, the discharge solution may enter the battery/cell and thus the discharge process may continue for some time after extracting the batteries/cells from the discharge medium, hence providing an even shorter processing time in the discharge medium needed to arrive at an acceptable remaining cell voltage for the next step in the recycling process.

Battery cells in general comprise an anode, cathode, separator and electrolyte. The electrolyte acts as a conductor allowing ions to move between the positive electrode (cathode) and the negative electrode (anode) and in the reverse, in an oxidation and reduction reaction respectively. In lithium-ion secondary batteries (LIBs), lithium ions move from the anode to the cathode during discharge. The separator is meant to allow the transfer of ions but not to allow a short circuit between the anode and cathode. Furthermore, a battery cell typically comprises a casing for housing the electrodes and the electrolyte, current collectors or terminals and various safety devices, such as polymer gaskets, and one or more vents or valves for venting during thermal runaway. The positive terminal is connected to the cathode, e.g., by an aluminum tab, whereas the negative terminal is connected, e.g., by a copper tab, to the anode. The positive and negative terminals form the electric poles of the battery cell. The terms “electric pole” or “pole” and “terminal” are used interchangeably herein.

Batteries in general are characterized by their capacity and operating voltage. The operating voltage of a battery cell is limited by the potential difference across the terminals of the battery when no current is being drawn, also known as the open circuit voltage (Voc). For safe operation, battery cells are typically limited to an operating voltage of 4.2 V. Over a given voltage, a cell can only deliver a specific amount of electric charge or current, this is known as the capacity (Q) of the battery which is measured in ampere hours (Ah). The capacity is limited by the electrode, particularly cathode materials.

Whether a battery cell is fully charged or not is monitored using the State of Charge (SOC). The SOC is defined as the available electric charge over the full capacity of the battery. At 100% SOC a battery cell is fully charged and has its full capacity. At 0% SOC, the cell has little capacitance left and can supply little current. 0% SOC typically means that about 2.5-2.8 V remains. Based on the SOC and type or size of a battery cell, the energy content of the battery cell may be derived.

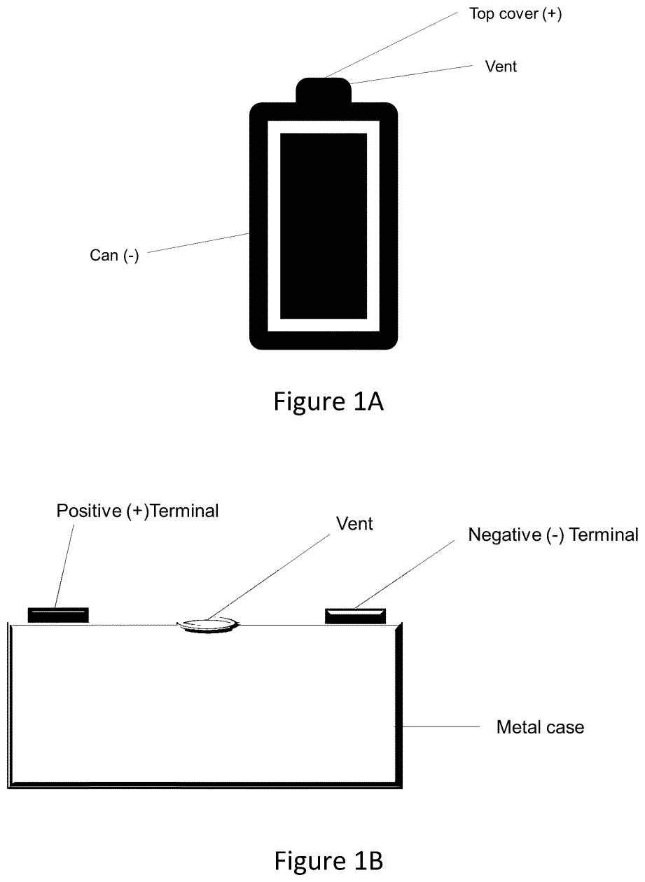

Cells are typically equipped with a safety feature called venting, where the batteries/cells have one or more vents (safety vent/vent hole), i.e., exhaust gas holes for venting during thermal runaway and insulation plates between e.g., the jelly roll and the casing, to avoid a short circuiting. During venting the air around the cells is displaced, which creates an oxygen starved atmosphere where the gases may not ignite, however, if the venting is not quick enough or not activated, gas formation in the cell can cause an increase in the internal pressure, causing an explosion and/or a fire. Cell containers come in various sizes and shapes depending upon energy and power requirements as well as the compartment in which the cell will be housed. Both cylindrical and prismatic cells are widely used, where cylindrical cell containers typically have two components: a large cylindrical can and a positive terminal cap, and vents have been provided on both the cylindrical cell can and the cap. The basic structure of such a cylindrical battery is shown in FIG. 1A, where the positive and negative poles and a vent is shown. Commercial lithium-ion cells typically have a current-limiting PTC (positive temperature coefficient) device installed in the cell cap to limit external currents in the event of an external short to the cell. The prismatic cells typically are constructed with a metal casing having two external terminals at the top and a safety vent, which vent may be placed between said terminals as illustrated in FIG. 1B.

Salt solution discharge is the method of submerging a cell in a salt solution for up to 24 hours. In this process, the dissolved salt acts as an electrolyte undergoing electrolysis, conducting electrons between the poles in a slow short circuit. The processes typically involve submerging the cell in 5 wt. % NaCl for up to 24 hours. The use of other salts besides NaCl has been suggested, such as Na2CO3, K2CO3, NaHCO3, NaNO2, NH4OH, FeSO4, ZnSO4 and Na2SO4. Problems such as corrosion of the cell casing causes leakage of the active materials and electrolyte, thereby releasing toxic substances or allowing self-ignition of the battery has been observed, as well as, when submerging high voltage battery packs or modules in salt water, arcing and a resultant fire.

A discharge solution of the current invention may be a salt solution as described above, but it may also be an aqueous solution without salt, or substantially without salt, such as a water solution. Electrolysis of water, also referred to as water splitting, is the process of using electricity to decompose water into oxygen and hydrogen gas by a process called electrolysis. Hydrogen gas released in this way can be used as hydrogen fuel, or remixed with the oxygen to create oxyhydrogen gas, which is used in welding and other applications. It requires a minimum potential difference of 1.23 volts. It has been observed that using water as a discharge medium provides approximately the same results as using a salt solution, without the drawbacks of corrosion etc. experienced when using salt solutions. However, using salt in the discharge medium may provide other benefits, such as binding HF to avoid development of toxic fumes. Hence, in some embodiments a low concentration of salt is preferred.

The present disclosure relates to novel and enhanced processes for discharging battery cells for battery recovery, where the discharging takes place before crushing and metal recovery. The present processes comprise several steps, where each of them contributes to a faster and/or a more efficient discharging, where the combinatory effects of all, or fewer, of these steps provide a large improvement of the process. The discharging processes comprise a first step of puncturing of the vent of the battery cell (one or several may be punctured if several are present). By puncturing the vent before submersion, or just after or upon submersion in the discharge medium, prior to the discharging, the discharge medium is allowed to enter the cell during submersion. The medium in the cell can thereafter react with both electrodes directly, speeding up the process of reducing the cell voltage. The vent is punctured, the battery/cell submerged in the discharge medium such that at least the electric poles of the battery/cell is covered with the electrically conductive fluid, and the battery/cell is allowed to discharge in the medium until the cell voltage has reached a cell voltage threshold. Since it has been found that a complete discharge is not needed, and since the discharge process will continue for a while after removal from the discharge medium due to the medium having entered into the cell through the vent, the cell voltage threshold is set to be above 0V, and is typically within the range of 1.0-2.5 V.

The approximate time for the battery cell to reach said threshold could be previously determined before the discharge process begins, being determined based on the energy content given by the size/type of battery cell and SOC. Based on previously knowledge of similar batteries of similar sizes and SOC, the time for the battery to reach said threshold may be predicted/estimated, i.e. based on previous collected experimental data of behaviors of similar batteries in previous discharge processes or test runs. Based on said estimated time, the battery cells may be grouped so that cells having similar estimated times are within the same group, and for each group a processing time may be determined before the discharge process has begun. Thus, a cell in a group of cells will then be submerged in the discharge medium for a predetermined processing time. As an alternative, a randomly determined time, i.e., not based on cell properties may be used, for example when the cell is damaged or is unknown, which random time may be selected for example as one of the most common processing times used for generic or similar type of cells. When the estimated predetermined or randomly predetermined time has passed, the battery cells may be removed from the discharge medium/solution and the remaining cell voltage may be measured, i.e., performing voltage validation. If the remaining cell voltage has reached or is below the cell voltage threshold, the battery cells may be sent to the next step in the recycling process. If the threshold has not yet been reached, the battery cells may be submerged again in the discharge solution for an additional processing time. This additional processing time may be preset to a certain duration, such as the same duration as the initial processing time or less, or may depend on the remaining cell voltage in view of the target cell voltage threshold of the cell, and estimated depending on previous knowledge of the discharging times for similar batteries (of similar energy content). Discharging times of submerging the battery cells into the discharge medium for the present processes are typically within the range of 2-8 hours, such as 4-6 hours.

The present solution discharge method for discharging the cells to be recycled, before the crushing and sorting step, is performed in an aqueous solution. In some embodiments said an aqueous solution is water. In other embodiments, said an aqueous solution is an aqueous salt solution. The ionic content of the solution allows electrochemical reactions, forming mainly oxygen and hydrogen gas, to take place when a cell is submerged in the solution. In some embodiments, the discharge medium is an aqueous salt solution, having a salt concentration of 0-15 wt. %. The salt solution may comprise one or more salts selected from Na₂CO₃, NaHCO₃, K₂CO₃, NaNO₃, NaNO₂, FeSO₄, NH₄OH and NaSO₄. In one embodiment, the discharge medium is an aqueous salt solution comprising Na₂CO₃, wherein the Na₂CO₃ concentration is in the range of 1-15 wt. %, such as 1-5 wt. %, or 1-8 wt. %. In some embodiments the Na₂CO₃ concentration is 10 wt. %, in other embodiments it is 5 wt. %, and in yet other embodiments it is 1 wt. %. By using sodium carbonate in a range around 1 wt. %, it has been seen that an efficient discharging procedure can be maintained without e.g., any major corrosion of the cell can material.

Before the discharging method is stated, an ID tag (such as a QR code) of the cells/packs may be read, which may comprise information concerning e.g., state of charge (SOC), type/size of battery, which properties indicates the energy content of the cells/packs, from which an estimated discharge time in the discharge medium for reaching a target cell voltage threshold for the battery cell may be estimated. Based on said estimated discharge time, a predetermined processing time t may be set, which may be the same as the estimated discharge time, or determined based on a discharge time range of a group that the battery cell has been sorted in. Thereafter, the cell/cells in a group are submerged in a discharge medium and discharged through electrolysis of water at the battery terminals. After voltage validation and a washing step, the cells are crushed and sorted for further processing.

After puncturing the vent or vents, the battery/battery cell is submerged into a discharge medium having a certain temperature, such as 40-60 degrees Celsius, and salt concentration, which may vary with different embodiments. The temperature can also be lower than 40 degrees, for example, room temperature (about 20-22 degrees Celsius), i.e. the temperature may be in the range of 20-60 degrees Celsius. The discharging process in the discharge medium is terminated, by removing the battery cell from the medium, when the cell voltage of the battery has reached a certain (target) cell voltage threshold, which threshold may range from e.g. 2.2 V to 1.5 V, such as 2.0 V, 1.8 V or 1.6 V. Since the discharging continues for a bit after the cell has been removed from the medium, the actual cell voltage in the following steps may be even lower that the target. Thus, preferably the battery cells are stored for a certain time before the following crushing step, such as for example for 1-24 hours. During this time the cell voltage will drop below the threshold (the cell voltage the cell has when extracted from the medium), such as for example from 1.2 V to 0.5 V. Based on properties of the battery cell, a time (discharge time in the discharge medium) to reach a target cell voltage threshold may be estimated, and based on said estimation, the battery cell may then be sorted into a group of a plurality of battery cells, which all have similar estimated discharge times. The battery cell/battery cell group will then be submerged into the discharge medium for a predetermined processing time. The predetermined processing time may be the same as the estimated discharge time for the battery cell, or it may be set based on the discharge time range of the group. Thus, terminating the discharge process in the discharge medium when the cell voltage of the battery has reached the target cell voltage threshold is performed by allowing the battery cell to be submerged in the discharge medium for the predetermined processing time. It has been found that a discharging process aborted at voltage as high as ˜1.8 V, or even as high as 2.2 V, is enough with respect to managing a safe crushing and sorting procedure, as the discharging process will continue after removal from the discharge medium, such as down to 0.5 V By not discharging the cells from for example 1.8 V to 0 V, a large amount of processing time in the discharge medium is saved. By implementing the described features, the discharge process, before crushing and sorting, will be faster. This will in turn lead to reduced capex due to a minimized production line as well as reduced storage facilities for undischarged cells.

Accordingly, in the processes of the present disclosure, an ID tag of the cells/packs may be read, which may comprise information concerning of a SOC and other parameters affecting the discharge time of the battery, which may be used to estimate or determine a processing time, t. Thus, the batteries may be sorted into different categories depending on the SOC, or an estimated discharge time, and a processing time may be predetermined for a cell or a group of cells based on its/their estimated processing times. This allows for adaptive discharge based on SOC (or energy content), which is connected to expected discharging time, by using separate discharging lines for each SOC range or for each time t or estimated discharge time range. The SOC of the cells may be between 100% to 0%, and a SOC range may be for example 5%, 10%, or 20%, such as one group of 0-5%, or 0-10%, or 0-20%, and the next group of 6-10% or 11-20%, or 21-40%, etc. Accordingly, a first group of batteries having a similar estimated discharge time may be submerged jointly in the same discharge medium for a corresponding predetermined processing time, while other batteries having another predicted discharge time may be grouped in another category, in a second group, and discharged in a separate process from the first group.

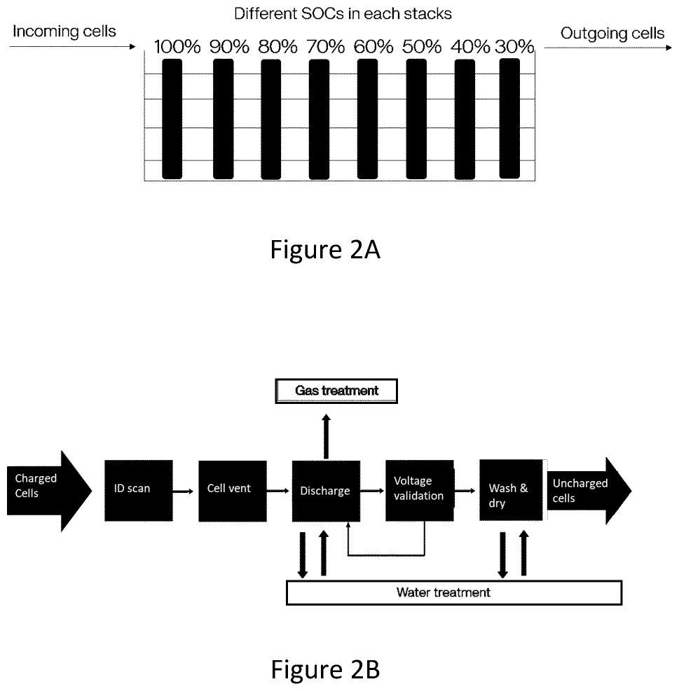

Thus, in an example as shown in FIG. 2A, illustrating a discharging process including an adaptive flow of cells based on SOC/energy content, cells are identified with respect to e.g., the SOC before the discharging. The incoming cells are sorted in different stacks depending on their remaining SOC percentage, before proceeding to the next step of discharging, as illustrated in FIG. 2. This opens up the possibility to run several parallel processing lines for cells with similar SOC. By separating the cells in groups according to SOC (or corresponding energy content or discharge times), the processing time for each SOC range can be tailored to suit the estimated discharging time. With the alternative being processing all cells for a time period needed for the most time intensive cell, such a process saves a large amount of time on a system level. In FIG. 2B a complete process starting with a charged cell proceeding to be ID scanned, opening of the cell vent, discharging in a discharge media, performing voltage validation, followed by washing and drying, while under the influence of the water solution proceeding with discharging the cell from within after removal from the discharge medium, resulting in a discharged cell, i.e., a cell having an acceptable remaining cell voltage for proceeding to the next step of crushing, such as 0.5 V.

The sorting into different groups may be based on the SOC, where it may be estimated that it will be good enough to sort based on the SOC only. In other examples, a more precise sorting may be applied. The discharge time depends on the SOC and remaining capacity, where the more a cell loses its capacity, the quicker it can discharge, and vice versa. Thus, in an example, two cells may have the same SOC but different capacity retention. The cell with higher capacity retention is more likely to discharge faster because it has already lost more of its capacity and can reach the lower voltages quicker. This may also be taken into account when sorting/grouping the cells.

A solution discharging line according to the described invention is capable of processing cells at all state of charges (0-100% SOC). By not excluding any cells, an efficient process can be maintained. Further, also broken cells, which are rejected for electrical discharging, may be discharged using the present processes. Thus, scrap comprising battery cells may be recycled using the processes of the present disclosure. Also, processing times may be adapted to the needs of the specific cell. Hence, besides being faster, the present processes also more specific and inclusive.

### EXAMPLE OPERATIONS

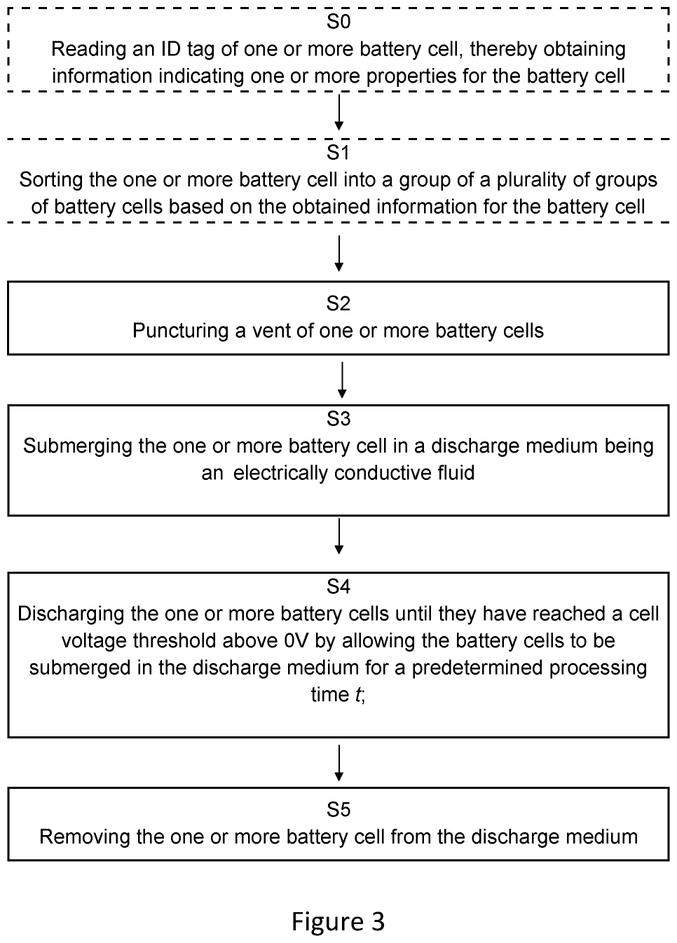

The proposed methods will now be described in more detail referring to FIG. 3. It should be appreciated that FIG. 3 comprises some operations which are illustrated with a solid border and some operations which are illustrated with a dashed border. The operations which are illustrated with solid border are operations which are comprised in the broadest example embodiment. The operations which are illustrated with dashed border are example embodiments which may be comprised in, or a part of, or are further embodiments which may be taken in addition to the operations of the broader example embodiments. It should be appreciated that the operations do not need to be performed in order. Furthermore, it should be appreciated that not all of the operations need to be performed.

FIG. 3 illustrates a process for discharging of rechargeable battery cells, said battery cells having electric poles and one or more vents, the method comprising puncturing (S2) a vent of one or more battery cell; submerging (S3) the one or more battery cell in a discharge medium such that at least the electric poles and the punctured vent of the one or more battery cell are covered with the discharge medium, wherein the discharge medium is an electrically conductive fluid; discharging (S4) the one or more battery cell until it has reached a target cell voltage threshold by allowing the battery cell to be submerged in the discharge medium for a predetermined processing time t, wherein the target cell voltage threshold is above 0 volts, V; and removing (S5) the one or more battery cell from the discharge medium. The target cell voltage threshold is in the range of 1.0 V to 2.5 V, or in the range of 1.5 V, to 2.2 V, such as 1.8 V, and the battery cell is said to have reached the threshold when the remaining cell voltage is at or below the threshold. The processing time t is typically between 2-8 hours.

The discharging (S4) of the one or more battery cell until it has reached a target cell voltage threshold is achieved due to the predetermined processing time t being determined based on knowledge about the properties of the battery cell indicating its SOC and/or energy content and thus the amount of discharging needed to reach the target cell voltage threshold under the present circumstances using the present discharge medium. In some instances, by allowing the battery cell to be submerged in the discharge medium for a predetermined processing time t, the target cell voltage threshold may not be completely reached, and discharging (S4) the one or more battery cell until it has reached (including that is has almost reached) a target cell voltage threshold and removing (S5) the one or more battery cell from the discharge medium (not shown in FIG. 3) may comprise allowing (S41) the one or more battery cell to be submerged in the discharge medium for a predetermined processing time t; removing (S51) the one or more battery cell from the discharge medium; performing (S6) a voltage validation of remaining cell voltage of the one or more battery cell by measuring the remaining cell voltage of the one or more battery cell; and on condition that the voltage validation shows that the remaining cell voltage is at or below the cell voltage threshold, sending (S7) the one or more battery cell to a next step in a battery cell recycling process; on condition that the voltage validation shows that the remaining cell voltage is above the cell voltage threshold, submerging (S42) the one or more battery cell in the discharge medium for additional discharging during an additional processing time; and removing (S52) the one or more battery cell from the discharge medium. Sending (S7) the one or more battery cell to a next step in a battery cell recycling process may comprise sending the one or more battery cell to be washed and then crushed, before metal extraction. In some embodiments, the process further comprises recovery of the electrically conductive fluid of the discharge medium by removing (S8) impurities from the electrically conductive fluid to obtain a raw electrically conductive fluid; and adjusting (S9) the concentration of the obtained raw electrically conductive fluid for reuse.

In one aspect, the process further comprises reading (S0) an ID tag of each one of the one or more battery cell, thereby obtaining information indicating one or more properties of the one or more battery cell; and sorting (S1) the one or more battery cell into a group of a plurality of groups of battery cells based on the obtained information for the battery cell, wherein each group of the plurality of groups will be treated in a separate discharging process in the following steps, i.e. steps S2 and forward. In some embodiments, sorting the one or more battery cell into a group of a battery cells is based on an estimated discharge time for the battery cell to reach the target cell voltage threshold being within a discharge time range for the battery cell group, or based on a state of charge, SOC, for the battery cell being within a SOC range for the battery cell group.

In one embodiment, a discharge time for each battery cell, i.e., a time to reach the target cell voltage threshold in the present discharging process, is estimated based on previous knowledge of battery cells having similar properties as the battery cell, wherein said properties include a state of charge, SOC, a type and size, and/or energy content, and wherein the processing time t is predetermined based on said estimated discharge time. In some embodiments, the predetermined processing time t for each one of the one or more battery cell is determined (i) as an estimated discharge time for the battery cell, i.e. being the same or substantially the same as the estimated discharge time, or (ii) based on an estimated discharge time range of the group that the battery cell has been sorted into, wherein the range includes the interval spanning from the shortest to the longest times estimated discharge times allowed for being sorted into said group, and the processing time t may be determined as any time withing said range, such as the longest time, the median or medium time, or the shortest time.

In some embodiments, an estimated discharge time for each one of the one or more battery cell to reach the target cell voltage threshold may be obtained from a lookup table based on the obtained information regarding the properties of each battery cell. Thus, based on previous knowledge and experimental data, a lookup table correlating a SOC or energy content of a battery cell for a target cell voltage threshold may be correlated to a discharge time to reach said threshold.

The discharge medium is an aqueous solution comprising a salt concentration of 0-15 wt. %, wherein 0% means a water-based solution without added salts. In some embodiments, the discharge medium is an aqueous salt solution comprising one or more salts selected from Na2CO3, NaHCO3, K2CO3, NaNO3, NaNO2, FeSO4, NH4OH and NaSO4. In some embodiments, the discharge medium is an aqueous salt solution comprising Na2CO3, wherein the Na2CO3 concentration is in the range of 1-15 wt. %, such as 1-8 wt. %, or 1-5 wt. %.

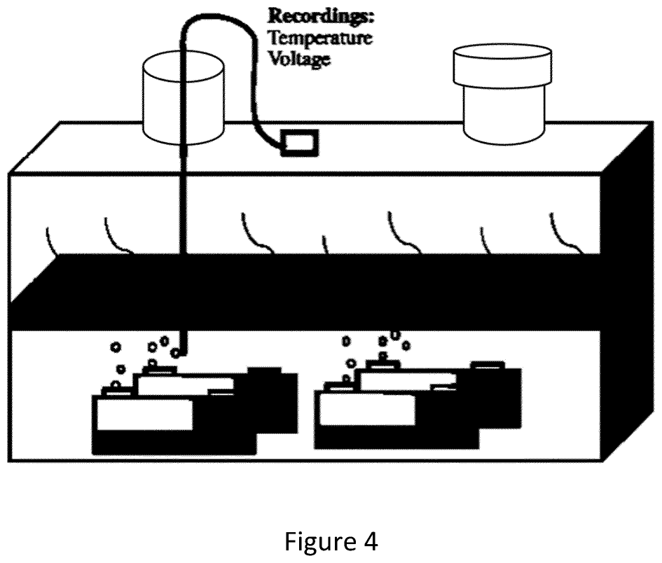

FIG. 4 illustrates a setting of a solution discharge process, where the prismatic type of cells (four cells illustrated in the present figure) with a punctured vent is placed in the conductive fluid (this conductive fluid can be 1 wt % Na₂CO₃ solution, for example). Recordings are done during the process, such as recording the temperature and voltage of each of the prismatic cells. After the processing time (or regularly during the process), the cells are lifted to measure the voltages. Alternatively, the voltages are determined continuously within the solution, e.g., by keeping the cells inside solution and measuring the voltage using a proper set-up and connections. The voltages are checked frequently after the process, until it is certain that the value(s) is stable or lower than the voltage measured right after the process, to make sure that there is no voltage rebound.

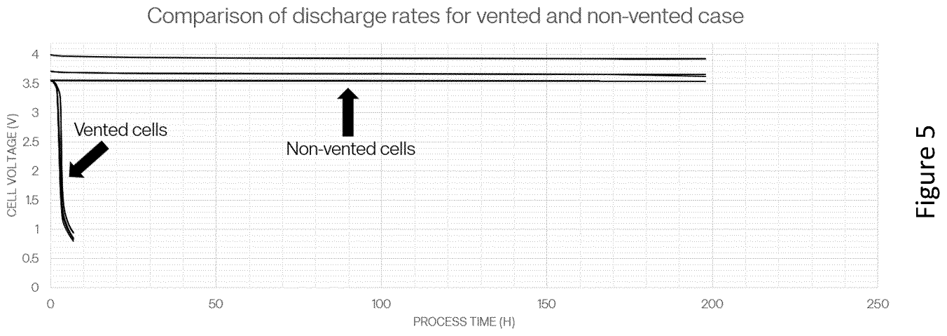

FIG. 5 illustrates a comparison of solution discharge rate with a punctured vent (vented) and without a punctured vent (non-vented case). Both vented and non-vented cells were subjected to the method as illustrated in FIG. 3, and the resulting remaining cell voltage (V) over time (processing time in hours) plotted in the diagram of FIG. 5. While the punctured vent case shows 7 hours of discharge for this specific example (taking less than 4 h to reach 1.8 V), it takes much longer time (more than 150 hours) for the opposite case (non-vented), thus demonstrating the efficiency of the method.

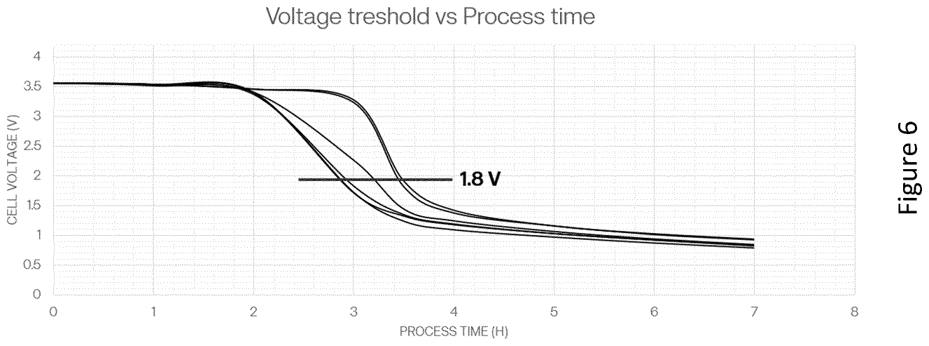

FIG. 6 shows an enlarged version of the vented case illustrated above in FIG. 5. The method starts with a cell voltage of around 3.55 V, which quickly start decreasing after about 2 to 3.3 hours of process time. It can be seen that the discharge threshold range (specifically 1.8 V for this example) is reached in 3 to 4 hours. After 7 hours the process was stopped at a remaining cell voltage of lower than 1V, as mentioned above.

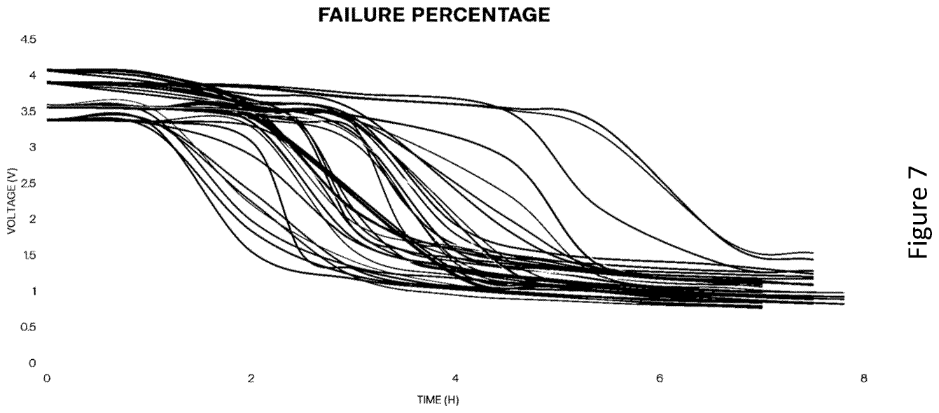

In FIG. 7 is illustrated failure rates in percent for processes of discharging battery cells, where FIG. 7 combines data from 45 different prismatic cells from many different discharge batches. It may be seen from this diagram that a discharge below 1.8 V is achieved within 8 hours for all cells, and hence the failure rate of the present method is 0%.

The content of this disclosure thus enables fast and effective discharging of batteries or battery cells, intact of damaged, by puncturing the vent of the battery cell, and terminating the solution bath, i.e., the part of the discharge process taking place in the discharge medium, at a cell voltage threshold above 0V, preferably above 1V.

In the drawings and specification, there have been disclosed exemplary aspects of the disclosure. However, many variations and modifications can be made to these aspects without substantially departing from the principles of the present disclosure. Thus, the disclosure should be regarded as illustrative rather than restrictive, and not as being limited to the particular aspects discussed above. Accordingly, although specific terms are employed, they are used in a generic and descriptive sense only and not for purposes of limitation.

The description of the example embodiments provided herein have been presented for purposes of illustration. The description is not intended to be exhaustive or to limit example embodiments to the precise form disclosed, and modifications and variations are possible in light of the above teachings or may be acquired from practice of various alternatives to the provided embodiments. The examples discussed herein were chosen and described in order to explain the principles and the nature of various example embodiments and its practical application to enable one skilled in the art to utilize the example embodiments in various manners and with various modifications as are suited to the particular use contemplated. The features of the embodiments described herein may be combined in all possible combinations of processes, products, and systems. It should be appreciated that the example embodiments presented herein may be practiced in any combination with each other.

It should be noted that the word “comprising” does not necessarily exclude the presence of other elements or steps than those listed and the words “a” or “an” preceding an element do not exclude the presence of a plurality of such elements. It should further be noted that any reference signs do not limit the scope of the claims, that the example embodiments may be realized in the broadest sense of the claims.

1-15. (canceled)

16. A method for discharging of rechargeable battery cells, said battery cells having electric poles and one or more vents, the method comprising:
puncturing (S2) a vent of one or more battery cell;
submerging (S3) the one or more battery cell in a discharge medium such that at least the electric poles and the punctured vent of the one or more battery cell are covered with the discharge medium, wherein the discharge medium is an electrically conductive fluid;
discharging (S4) the one or more battery cell until it has reached a target cell voltage threshold by allowing the battery cell to be submerged in the discharge medium for a predetermined processing time t, wherein the target cell voltage threshold is above 0 volts, V; and
removing (S5) the one or more battery cell from the discharge medium.

17. The method according to claim 16, wherein the target cell voltage threshold is in the range of 1.0 V to 2.5 V, and wherein the battery cell is said to have reached the threshold when the remaining cell voltage is at or below the threshold.

18. The method according to claim 17, wherein the target cell voltage threshold is in the range of 1.5 V, to 2.2 V, such as 1.8 V.

19. The method according to claim 16, further comprising:
reading (S0) an ID tag of each one of the one or more battery cell, thereby obtaining information indicating one or more properties of the one or more battery cell; and
sorting (S1) the one or more battery cell into a group of a plurality of groups of battery cells based on the obtained information for the battery cell, wherein each group of the plurality of groups will be treated in a separate discharging process in the following steps.

20. The method according to claim 16, wherein a discharge time for each battery cell to reach the target cell voltage threshold is either i) estimated based on previous knowledge of battery cells having similar properties as the battery cell, wherein said properties include a state of charge, SOC, a type and size, and/or energy content, or ii) randomly determined, and wherein the processing time t is predetermined based on said estimated or randomly determined discharge time.

21. The method according to claim 16, wherein the processing time t, is between 2-8 hours.

22. The method according to claim 19, wherein sorting the one or more battery cell into a group of a battery cells is based on an estimated discharge time for the battery cell to reach the target cell voltage threshold being within a discharge time range for the battery cell group, or based on a state of charge, SOC, for the battery cell being within a SOC range for the battery cell group.

23. The method according to claim 19, wherein an estimated discharge time for each one of the one or more battery cell to reach the target cell voltage threshold may be obtained from a lookup table based on the obtained information regarding the properties of each battery cell

24. The method according to claim 19, wherein the predetermined processing time t for each one of the one or more battery cell is determined (i) as an estimated discharge time for the battery cell or (ii) based on an estimated discharge time range of the group that the battery cell has been sorted into.

25. The method according to claim 16, wherein discharging (S4) the one or more battery cell until it has reached a target cell voltage threshold and removing (S5) the one or more battery cell from the discharge medium comprises:
allowing (S41) the one or more battery cell to be submerged in the discharge medium for a predetermined processing time t;
removing (S51) the one or more battery cell from the discharge medium;
performing (S6) a voltage validation of remaining cell voltage of the one or more battery cell by measuring the remaining cell voltage of the one or more battery cell; and
on condition that the voltage validation shows that the remaining cell voltage is at or below the cell voltage threshold,
sending (S7) the one or more battery cell to a next step in a battery cell recycling process;
on condition that the voltage validation shows that the remaining cell voltage is above the cell voltage threshold,
submerging (S42) the one or more battery cell in the discharge medium for additional discharging during an additional processing time; and
removing (S52) the one or more battery cell from the discharge medium.

26. The method according to claim 16, wherein the discharge medium is an aqueous solution comprising a salt concentration of 0-15 wt. %.

27. The method according to claim 16, wherein the discharge medium is an aqueous salt solution comprising one or more salts selected from Na2CO3, NaHCO3, K2CO3, NaNO3, NaNO2, FeSO4, NH4OH and NaSO4.

28. The method according to claim 16, wherein the discharge medium is an aqueous salt solution comprising Na2CO3, wherein the Na2CO3 concentration is in the range of 1-15 wt. %, such as 1-8 wt. %, or 1-5 wt. %.

29. The method according to claim 23, wherein sending (S7) the one or more battery cell to a next step in a battery cell recycling process comprises sending the one or more battery cell to be washed and then crushed, before metal extraction.

30. The method according to claim 16, wherein the method further comprises recovery of the electrically conductive fluid of the discharge medium by:
removing (S8) impurities from the electrically conductive fluid to obtain a raw electrically conductive fluid; and
adjusting (S9) the concentration of the obtained raw electrically conductive fluid for reuse.
